(19) United States
(12) Patent Application Publication
(10) Pub. No.: US 2016/0228833 A1
(43) Pub. Date: Aug. 11, 2016

(54) Additive System for Use With Post Mix Dispensing Machine

(71) Applicant: Dispenser Beverages Incorporated, San Leandro, CA (US)

(72) Inventor: Robert Scott Riel, Alamo, CA (US)

(73) Assignee: Dispenser Beverages Incorporated, San Leandro, CA (US)

(21) Appl. No.: 15/130,406

(22) Filed: Apr. 15, 2016

Related U.S. Application Data
(63) Continuation of application No. 14/038,662, filed on Sep. 26, 2013, now abandoned.
(60) Provisional application No. 61/707,696, filed on Sep. 28, 2012.
(60) Provisional application No. 61/784,722, filed on Mar. 14, 2013.

(51) Int. Cl. B01F 5/04; B67D 1/00; B67D 1/12; B01F 15/02

(52) U.S. Cl. CPC B01F 5/0498; B01F 15/0216; B01F 15/0243; A23L 1/308; B67D 1/0028; B67D 1/1231; B67D 1/1279; B01F 2215/0014; A23V 2002/00

(57) ABSTRACT

An additive system is used with a post mix dispensing machine having a liquid inlet, and a supply of an additive for mixing with the liquid from the liquid inlet. A pump, having an additive inlet and an additive outlet, is coupled to a source of power. An additive supply line is coupled to the additive inlet. The additive supply line is coupleable to a source of an additive. A liquid delivery line connects the liquid inlet to a mixture delivery outlet. An additive delivery line connects the additive outlet to a mixing point along the liquid delivery line. An additive flow adjuster is used to control the flow of additive from the pump. Additive flowing through the additive delivery line mixes with liquid flowing through the liquid delivery line for passage to the mixture delivery outlet.

### CROSS-REFERENCE TO OTHER APPLICATIONS

This application is a continuation of U.S. patent application Ser. No. 14/038,662 filed 26 Sep. 2013, which claims the benefit of U.S. Provisional Patent Application No. 61/707,696, filed 28 Sep. 2012, and U.S. Provisional Patent Application No. 61/784,722, filed 14 Mar. 2013; the disclosures of which are incorporated by reference.

### BACKGROUND OF THE INVENTION

Ingesting sufficient amounts of dietary fiber is necessary for good health. The State of California is enforcing the USDA Title 22 Dietary Recommended Intakes (DRIs) fiber requirements for long term care seniors. Dietitians have been directed to add new fiber sources to healthcare menus. It is anticipated that other states will follow California's lead. Fiber requirements have increased over the years ranging from 19 to 38 grams per day depending on sex and age. New daily requirements for seniors are 30 grams for men, 25 grams for woman.

The healthcare industry is looking for the ability to provide dispensed concentrate fiber juice (cost and labor considerations) in standard/specific amount of fiber content in order to satisfy DRI requirements. The current fortification standard is 5 grams per (4) ounce ready to serve (RTS) beverage. Current fiber juice options are largely limited to costly single strength aseptic orange juice and apple juice.

Designing fiber fortified juice concentrates is prohibitive because the high percentage of solids, fructose and sucrose levels (50-75 degree Brix) inhibit fiber absorption. Therefore manufacturing fiber concentrates into a 4-5:1 conventional hand mix or dispenser packs is difficult and impractical. Additionally, if concentrates were packed with fiber, the market would be limited to low concentrate ratios (2-3:1) and only the more popular juices like orange and apple juice. Additional stock-keeping unit (SKU) costs for such fiber concentrates are impractical. Healthcare facilities require fiber juices in the morning and non-fiber juices in the afternoon.

### BRIEF SUMMARY OF THE INVENTION

An additive system is used with a post mix dispensing machine having a liquid inlet, and a supply of an additive for mixing with the liquid from the liquid inlet. A pump, having an additive inlet and an additive outlet, is coupled to a source of power. An additive supply line is coupled to the additive inlet. The additive supply line is coupleable to a source of an additive. A liquid delivery line connects the liquid inlet to a mixture delivery outlet. An additive delivery line connects the additive outlet to a mixing point along the liquid delivery line. An additive flow adjuster is used to control the flow of additive from the pump. Additive flowing through the additive delivery line mixes with liquid flowing through the liquid delivery line for passage to the mixture delivery outlet. In some examples, a backflow preventer valve is used along one or both of the additive delivery line and of the liquid delivery line.

Other features, aspects and advantages of the present invention can be seen on review of the drawings, the detailed description, and the claims which follow.

### BRIEF DESCRIPTION OF THE DRAWINGS

FIG. 1 is a simplified illustration of an additive system designed for use with post mix dispensing machines. FIG. 2 is a simplified illustration of an alternative example of the additive system of FIG. 1.

### DETAILED DESCRIPTION OF THE INVENTION

The following description will typically be with reference to specific structural embodiments and methods. It is to be understood that there is no intention to limit the invention to the specifically disclosed embodiments and methods but that the invention may be practiced using other features, elements, methods and embodiments. Preferred embodiments are described to illustrate the present invention, not to limit its scope, which is defined by the claims. Those of ordinary skill in the art will recognize a variety of equivalent variations on the description that follows. Unless otherwise stated, in this application specified relationships, such as parallel to, aligned with, or in the same plane as, mean that the specified relationships are within limitations of manufacturing processes and within manufacturing variations. When components are described as being coupled, connected, being in contact or contacting one another, they need not be physically directly touching one another unless specifically described as such. Like elements in various embodiments are commonly referred to with like reference numerals.

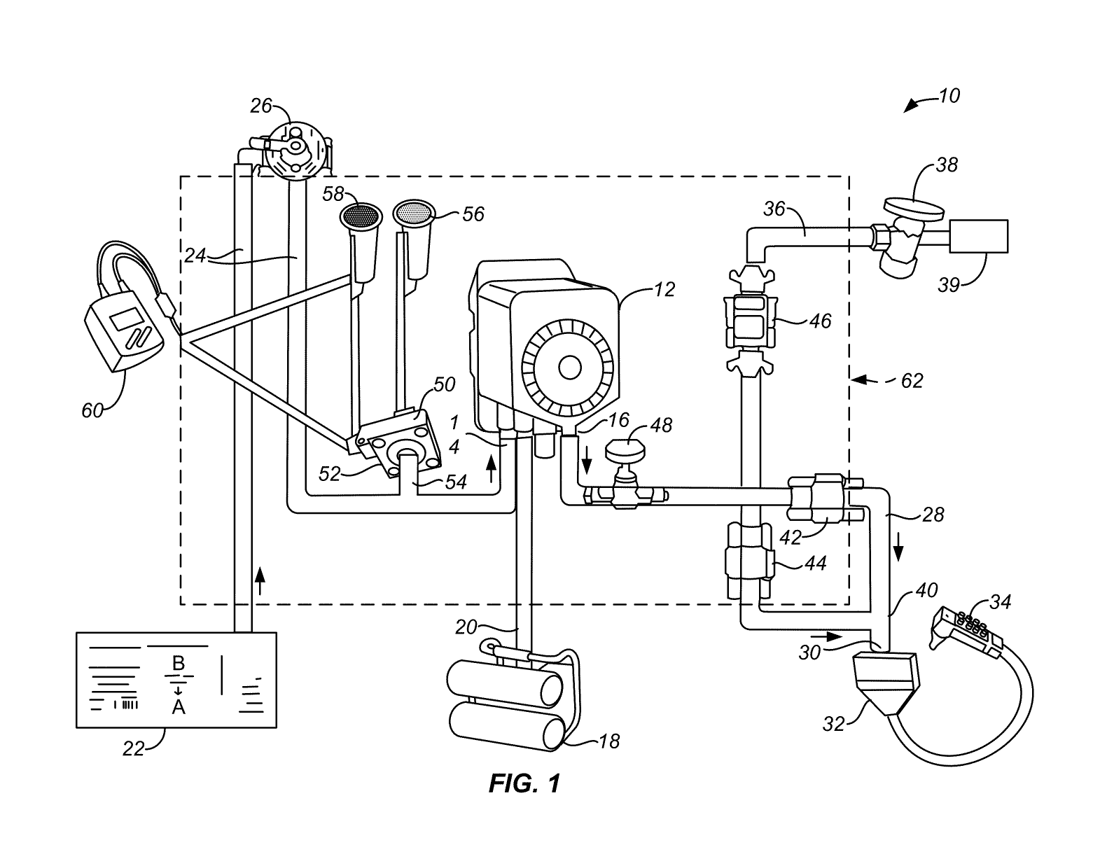

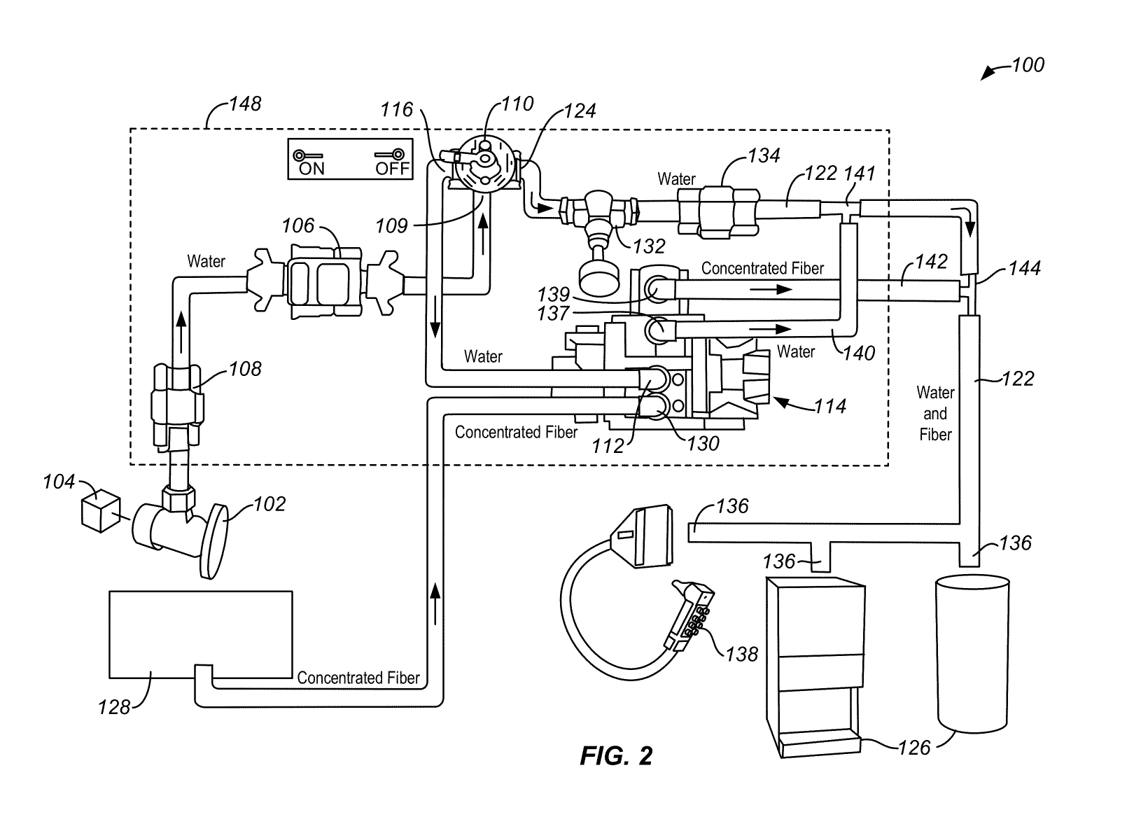

FIG. 1 diagrammatically illustrates various components of additive system 10. System 10 includes a pump 12 having a pump inlet 14 and a pump outlet 16. In this example, pump 12 is powered by a pressurized gas, typically compressed air from a compressed air power source 18, connected to pump 12 by a compressed air line 20. Pumps powered by other types of power sources can also be used. Pump inlet 14 is connected to a supply 22 of an additive by additive supply line 24. A flow control valve 26, in this example in the form of a shutoff valve, is positioned along line 24 and is placeable in an open state permitting additive to flow along line 24 and in a closed state halting flow of additive along the line.

In one example, the additive from supply 22 is a fiber concentrate. The fiber concentrate can be a dietary soluble liquid fiber concentrate with, for example, 8.5 g of fiber per liquid ounce. The liquid fiber concentrate can be contained in a shelf stable, 3 gallon bag in box format. Other storage formats and different fiber concentrations can be used.

An additive delivery line 28 connects pump outlet 16 to an inlet 30 of a bar gun manifold 32 connected to a conventional bar gun 34 can be components of a conventional post mix dispenser, such as those manufactured by IMI Cornelius, Inc. A water delivery line 36 connects a water inlet 38, typically in the form of a shutoff valve, to a mixing point 40 just upstream of inlet 30 of bar gun manifold 32. Water inlet 38 can be connected to a municipal water supply or other water source 39. In some examples, inlet 38 can be connected to a source of liquid other than water. In some examples, the fiber concentrate from supply 22 can be delivered directly to inlet 30 without being mixed with water or another liquid. However, in this example, fiber concentrate is mixed with water before it reaches mixing point 40. Using fiber concentrate, or other additive, in a concentrated form is both cost-effective and allows the user to adjust concentration of fiber concentrate entering inlet 30 of bar gun manifold 32.

Backflow preventers 42, 44 are used along additive delivery line 28 and water delivery line 36, respectively. The water pressure regulator 46 is used along water delivery line 36 between backflow preventer 44 and water inlet 38 to control the pressure of water entering mixing point 40. An additive flow adjustment device 48, which can be in the form of a flow restricting valve, controls the amount of fiber concentrate, or other additive, to be mixed with water at mixing point 40.

In some examples, other means for adjusting the amount of additive flowing through pump 12 can be used. For example, the flow rate of pump 12 could be adjustable, or a flow adjustment device 48 could be placed along additive supply line 24. Also, the functions of flow control valve 26 and flow adjustment device 48 could be incorporated into a single device. Flow control valve 26 could be a component of or associated with additive supply 22 and not be a part of additive system 10.

Additive system 10 also includes a vacuum sensor switch 50 having an inlet 52 fluidly coupled to supply line 24 by a connector line 54. Vacuum sensor switch 50 senses when pump 12 is operating because the pressure within connector line 54 is at a partial vacuum. Switch 50 is connected to an on indicator light 56 and an off indicator light 58 to provide the user with a visual indication of whether or not pump 12 is operating. Sensor switch 50 and indicator lights 56, 58 are powered through a 12 V DC transformer 60. In some examples, pump 12 could be an electrically powered pump powered by electricity from, for example, transformer 60 or by batteries, preferably rechargeable batteries, with the batteries being components of system 10.

Most of the components of additive system 10 are housed within a common enclosure 62, which is drawn in dashed lines. Several components of additive system 10, including, in this example, shutoff valve 26, water inlet 38 and transformer 60, are commonly outside of common enclosure 62. This arrangement allows additive system 10 to be quickly and easily set up at an installation site and quickly coupled to an electrical outlet for transformer 60, additive supply 22, power source 18, water source 39, and bar gun manifold 32 of a post mix beverage dispenser.

Additive system 10 can be adjusted to deliver, for example, 1.25 g of fiber per ounce of a ready to serve beverage, that is 5 g per 4 ounce beverage. Other ratios greater than or less than 1.25 g of fiber per ounce can be achieved, such as through the use of additive flow adjustment device 48. The additive and water mixture which commonly enters inlet 30 of bar gun manifold 32 can be used with juice and other drink concentrates as well as directly in the preparation of, for example, oatmeal, gelatin, pancake mix or muffin mix.

In use, additive supply line 24 is connected to additive supply 22, power source 18 is connected to line 20, water inlet 38 is connected to water source 39, additive delivery line is connected to inlet 30, and transformer 60 is connected to an electrical outlet or other source of electricity. With power source 18 operating, and water inlet 38 opened, valve 26 is opened allowing pump 12 to draw additive from supply 22, along line 24, and through line 28. The operation of pump 12 is indicated by on indicator light 56. The fiber concentrate or other additive passing through line 28 mixes with water passing through line 36 at mixing point 44, after which it passes into inlet 30 of bar gun manifold 32. It is then typically mixed with a drink concentrate for dispensing through bar gun 34. The concentration of the additive can be changed using adjustment device 48.

An alternative example of an additive system 10 is shown in the above-referenced provisional patent application filed on 28 September 2012, the disclosure of which is incorporated by reference. This alternative example is discussed below as additive system 100 shown in FIG. 2.

Additive system 100 is a closed, self-contained, water pressure driven pumping system for post-mix dispensing machines and devices. System 100 includes a pressurized water inlet 102 connected to a water supply 104, such as a municipal water supply, for supplying water to the system through a water line 105. A water pressure regulator 106 is positioned along water line 105 and is connected to water inlet 102 through a first backflow preventer valve 108. Valve 108 is between the water inlet 102 and the water pressure regulator 106. Water line 105 connects water pressure regulator 106 to an intake 109 of a bypass valve 110. Bypass valve 10 is connected to the water intake 112 of a positive displacement ratio pump 114 through a line 120 at the ON position outlet 116 of the bypass valve. Bypass valve 110 has an OFF position/bypass outlet 124 connected to a post-mix dispensing machine 126 or a bar gun device 138, collectively referred to as a dispenser machine, through a continuation 122 of water line 105. A separate supply 128 of concentrated additive (in this case, liquid fiber concentrate) is connected to additive intake 130 of the positive displacement ratio pump 114.

An equalizer valve 132 (which is a needle valve like the one that is used with a refrigerator's ice maker) is positioned along the continuation 122 of the water supply line 105 just downstream of the bypass valve 110. A second back flow preventer valve 134 is positioned downstream of the equalizer valve 132. The equalizer valve 134 can be used so that the amount of water added to the beverage concentrate in the post mix dispensing machine 126 is appropriate with or without the fiber added. The fiber concentrate is pumped at an exact ratio, mixed together (reconstituted) and then a second machine within the post-mix beverage dispenser 126 (electric or pneumatic there are many types) reconstitutes the fiber water with, for example, juice, tea, or other drink concentrates (second reconstitution).

Several outlet ports 136 enable connection to multiple post-mix dispensing machines 126 or devices, such as bar gun device 138, limited only by the number of outlet ports. When the bypass valve is in the “ON” position, water flows through water line 105, through intake 109, through the bypass valve 110, through on position outlet 116, through line 120 into water intake 112; water pressure drives the ratio pump 114 to operate. This creates a vacuum which draws the concentrate from its supply 128 of additive, (in this example, a bag-in-the-box supply) and mixes with the water into the desired ratio and can be dispensed through multiple post-mix dispensing machines 126 or bar-gun devices 138. When the bypass valve is in the “OFF” position, the water simply flows from intake 109 to outlet 124 and through the system without any additives directly to each post-mix machine for mixing with the particular other beverage concentrates (e.g., juice, coffee, tea, etc.) for full dilution and dispensing to the consumer.

As shown in FIG. 2, the water exiting water outlet 137 of pump 114 passes through a line 140 and into continuation 122 of water line 105 at a junction 141. Concentrated fiber from pump 114 passes from additive outlet 139 of pump 114 through a line 142 into continuation 122 of water line 105 at a junction 144. The bypass valve 124, the ratio pump 114, the first and second back flow preventer valves 108 and 134, the equalizer valve 132, and the water pressure regulator 106 are housed within a common enclosure 148.

An important aspect of the invention lies in the fact that this system adds the desired additive to the water before it is delivered to the post-mix dispensing machine for dispensing for consumption by consumer, rather being added in the mixing process by the post-mix dispensing machine.

Some basic concepts relating to the disclosed embodiment of additive system 100 discussed above with reference to FIG. 2 include the following. 1. The system is a closed, self-contained pumping system for post-mix dispensing machines, which mix a diluent, typically water, with a concentrated base before being dispensed. 2. The system is driven solely by water pressure from an external source without the need for an electrical power source. 3. The system adds desired additives (in this case, concentrated liquid fiber which may, for example, be in colloidal suspension or be soluble particulate additives) to the water prior to the water being delivered to the dispensing machine for combination with the concentrate for the particular beverage or beverages being dispensed for consumption by the consumer by the post-mix machine (i.e., a “host” pumping system). 4. The system contains a water pressure regulator. 5. The system is connected to a bypass valve to enable water to either flow into a positive displacement ratio pump for the mixing of the desired additive with water for dilution prior to the water being delivered to the post-mix machine or machines prior to being dispensed for consumption by the consumer or to deliver just water to the post-mix machine for mixing with the concentrate for the type of beverage or beverages dispensed by the post-mix machine or machines. 6. The system uses positive displacement ratio pump that operates by water pressure when water is introduced into the pump (the “ON” position of the bypass valve), which creates a vacuum to draw the additive into the pump for dilution to a desired level before being delivered to one or more post-mix dispensing machines for combination with the concentrate to create the beverage or other liquid being dispensed to the consumer by the post-mix machine or machines. 7. With the system the operator can control whether or not to add the available additive by operation of the bypass valve. 8. The self-contained, closed system has multiple outlet ports to enable multiple post-mix machines or devices (e.g., bar-gun dispensers) to be connected to the system. 9. The self-contained system is closed to maintain sanitation, ease of installation and aesthetics.

The above descriptions may have used terms such as above, below, top, bottom, over, under, et cetera. These terms may be used in the description and claims to aid understanding of the invention and not used in a limiting sense.

While the present invention is disclosed by reference to the preferred embodiments and examples detailed above, it is to be understood that these examples are intended in an illustrative rather than in a limiting sense. It is contemplated that modifications and combinations will occur to those skilled in the art, which modifications and combinations will be within the spirit of the invention and the scope of the following claims.

Any and all patents, patent applications and printed publications referred to above are incorporated by reference.

What is claimed is:

1. A system, for use with a dispenser machine, such as a post mix dispensing machine and a bar gun device, having a water inlet, for selectively adding an additive to the water entering the water inlet, comprising:
a bypass valve comprising:
a first inlet coupled to a pressurized water supply; and
first and second outlets, the bypass valve placeable in a bypass state coupling the first inlet and the first outlet, and in an operational state coupling the first inlet and the second outlet;
a system outlet, the system outlet coupleable to a water inlet of at least one dispenser machine;
a mixing line coupling the first outlet to the system outlet;
a supply of a water-transportable additive;
a ratio pump comprising:
an additive inlet coupled to the supply of water-transportable additive;
an additive outlet coupled to the additive inlet and coupled to the mixing line;
a water inlet coupled to the second outlet;
a water outlet coupled to the water inlet and coupled to the mixing line;
the pump being driven by pressurized water passing from the water inlet to the water outlet so that when the bypass valve is placed in the operational state, so that water passes from the water inlet to the water outlet, a suction force is created at the additive inlet thereby causing additive to pass from the supply of water-transportable additive, through the pump and to the mixing line to mix with water passing through the mixing line; and
when the bypass valve is placed in a bypass state, so that water no longer passes into the water inlet of the ratio pump, water can flow from the pressurized water supply, through the bypass valve, through the mixing line, and to the system outlet.

2. The system according to claim 1 further comprising a back flow preventer and a water pressure regulator placed along a line connecting the first inlet and the pressurized water supply.

3. The system according to claim 2, wherein the bypass valve, the ratio pump, the back flow preventer, and the water pressure regulator are housed within a common enclosure.

4. The system according to claim 1 wherein the additive outlet and the water outlet are coupled to the mixing line at first and second positions respectively, the first position being between the second position and the system outlet, whereby additive is mixed with water between the first position and the system outlet.

5. The system according to claim 4, further comprising a flow adjusting equalizer valve along the mixing line between the first outlet and the second position.

6. The system according to claim 1 wherein the additive comprises concentrated liquid dietary fiber.
